(19) United States
(12) Patent Application Publication
(10) Pub. No.: US 2008/0067262 A1
(43) Pub. Date: Mar. 20, 2008

(54) Aerosol Dispenser Assembly Having VOC-Free Propellant and Dispensing Mechanism Therefor

(75) Inventors: Padma Prabodh Varanasi, Racine, WI (US); Richard S. Valpey, Lindenhurst, IL (US)

Correspondence Address: S.C. JOHNSON & SON, INC., 1525 HOWE STREET, RACINE, WI, 53403-2236, US

(73) Assignee: S.C. Johnson & Son, Inc., Racine, WI (US)

(21) Appl. No.: 11/854,055

(22) Filed: Sep. 12, 2007

Related U.S. Application Data
(60) Provisional application No. 60/825,601, filed on Sep. 14, 2006.

(51) Int. Cl. B05B 1/24

(52) U.S. Cl. 239/13; 222/402.1; 239/133; 239/337

(57) ABSTRACT

An aerosol dispenser assembly is provided that enables a compressed gas propellant to be used to deliver liquid product in a fine mist, whereby the droplets of the mist have mean Sauter diameters of less than 35 μm. The dispensing system includes the use of a compressed gas propellant that is soluble in the liquid product at room temperature but that has a reduced solubility in the liquid product at temperatures exceeding room temperature The system also includes a valve attached to a pressurized container containing the liquid product and gas propellant. The valve includes an actuator cap that has a swirl chamber and an exit orifice and a built-in heater that at least partially surrounds the swirl chamber. As the propellant and liquid product stream exits the actuator cap, the heater heats the exit stream thereby decreasing the solubility of the compressed gas propellant in the liquid product, resulting in cavitation or the formation of compressed gas bubbles in the exit stream which produces unstable small ligaments of liquid product in the exit stream The small ligaments are naturally converted to small droplets having small diameters The droplets may then undergo secondary atomization to further reduce their size.

### CROSS-REFERENCE TO RELATED APPLICATION

This application is a non-provisional claiming priority under 35 USC §119(e) to provisional patent application No. 60/825,601, filed on Sep. 14, 2006

### FIELD OF THE DISCLOSURE

Improved aerosol dispenser systems are disclosed. More specifically, aerosol dispenser systems using a compressed gas propellant to expel a liquid product from a container are disclosed wherein the compressed gas propellant is innocuous, VOC-free, soluble in the liquid product at low temperatures and less soluble in the liquid product at higher temperatures. Still more specifically, the nozzle is equipped with a heating element to decrease the solubility of compressed gas propellant in the liquid product as it leaves the swirl chamber and passes through the exit orifice thereby causing cavitation in the exit stream leading to the formation of unstable product ligaments that form tiny droplets As a result, an effective aerosol system is provided without depending upon conventional hydrocarbon-based propellants

### BACKGROUND OF THE DISCLOSURE

Aerosol dispensers have been commonly used to dispense personal, household, industrial, and medical products, and provide a low cost, easy to use method of dispensing products that are best used as an airborne mist or as a thin coating on surfaces. Typically, aerosol dispensers include a container, which holds a liquid product to be dispensed, such as soap, insecticide, paint, deodorant, disinfectant, air freshener, or the like A propellant is used to discharge the liquid product from the container. The propellant is pressurized and provides a force to expel the liquid product from the container when a user actuates the aerosol dispenser by pressing an actuator button or trigger.

The two main types of propellants used in aerosol dispensers today include (1) liquefied gas propellants, such as hydrocarbon and hydrofluorocarbon (HFC) propellants, and (2) compressed gas propellants, such as compressed carbon dioxide or nitrogen To a lesser extent, chlorofluorocarbon propellants (CFCs) have been used. The use of CFCs, however, has essentially been phased out due to the potentially harmful effects of CFCs on the environment

In an aerosol dispenser using a liquefied gas-type propellant, the container is loaded with the liquid product and propellant to a pressure approximately equal to or slightly greater than the vapor pressure of the propellant. After being filled, the container still has a certain amount of space that is not occupied by liquid. This space is referred to as the “head space.” Since the container is pressurized to approximately the vapor pressure of the propellant, some of the propellant is dissolved or emulsified in the liquid product. The remainder of the propellant remains in the vapor phase and fills the head space. As the product is dispensed, the pressure in the container remains approximately constant as liquid propellant moves from the liquid phase to the vapor phase thereby replenishing discharged propellant vapor.

In contrast, compressed gas propellants largely remain in the vapor phase. As a result, the pressure within a compressed gas aerosol dispenser assembly decreases as the vapor is dispensed

While this aspect of using compressed gas propellants is disadvantageous, the use of compressed gas propellants may gain favor in the future as they typically do not contain volatile organic compounds (VOCs). In contrast, most liquefied gas-type propellants are hydrocarbon-based and contain volatile organic compounds (VOCs) thereby making their use subject to various regulations and therefore disadvantageous.

One way to reduce the VOC content in liquefied gas-type aerosols is to reduce the amount of the propellant used to dispense the liquid product without adversely affecting the product performance Specifically, before the techniques of commonly assigned U.S. Pat. No. 7,014,127 to Valpey et al. (incorporated herein by reference), reducing the propellant content in the aerosol air freshener resulted in excessive product remaining in the container after the propellant is depleted (product retention), an increase in the size of particles of the dispensed product (increased particle size), and a reduction in spray rate, particularly as the container nears depletion. Techniques of the '127 patent provide a way to minimize the particle size of a dispensed product in order to maximize the dispersion of the particles in the air and to prevent the particles from “raining” or “falling out” of the air, while reducing the amount of liquefied gas-type propellant to 25% by weight or less By reducing the amount of liquefied gas-type propellant in the container, the VOC is reduced.

The techniques of the '127 patent involve maintaining a Clark/Valpey (CV) value for the system at 25 or less, where CV=2.5(D−32)+10|Q−1.1|+2.6R, where D is the average diameter in micrometers of particles dispensed during the first forty seconds of spray of the assembly, Q is the average splay rate in grams/second during the first forty seconds of spray of the assembly, and R is the amount of the product remaining in the container at the end of the life of the assembly expressed as a percentage of the initial fill weight

One method of reducing the particle size of a dispensed liquid product in liquefied gas propellant systems is disclosed in U.S. Pat. No. 3,583,642 to Crowell et al which is incorporated herein by reference. The '642 patent discloses various spray heads that incorporate a “breakup bar” for inducing turbulence in a product/propellant mixture prior to the mixture being discharged from the nozzle outlet. Such turbulence contributes to reducing the size of the mixture particles discharged from the spray head. While the '642 patent discloses one-piece spray heads with breakup bars, breakup bats have been incorporated into nozzle inserts for spray heads

To provide an alternative to liquefied gas-type propellants and to eliminate any VOCs attributable to the propellant of an aerosol product, improved aerosol dispensing systems incorporating VOC-free compressed gas propellants are needed. However, to satisfy consumers, the employment of VOC-free compressed gas propellants should result in aerosol droplets with physical properties that are equivalent to or better than droplets produced by liquefied gas-type propellants

Specifically, a Sauter mean diameter is defined as the diameter of a droplet having the same volume/surface ratio as the entire spray Conventional liquefied gas-type aerosol systems provide Sauter mean diameters at or below 35 μm The same performance or better is needed for some compressed gas propellant systems.

The small droplet size of conventional aerosol systems is obtained by exploiting the phenomena of cavitation within the area leading to the exit nozzle Cavitation involves the formation of bubbles in the exit stream that form thin ligaments of liquids which grow into primary droplets. A Weber number for a droplet is a ratio of inertia forces to surface tension force. If the Weber number exceeds a critical value, the droplet can overcome the effects of surface tension and break up into smaller droplets, which is preferred. Thus, to effectively compete with liquefied gas-type systems, a compressed gas system is needed that provides good cavitation and that produces droplets with high Weber numbers.

### SUMMARY OF THE DISCLOSURE

An aerosol dispenser assembly is provided that comprises a container holding a liquid product and a compressed gas propellant for propelling the liquid product from the container. The compressed gas propellant comprises a gas that is soluble in the liquid product at room temperature and that has a reduced solubility in the liquid product at temperatures exceeding room temperature. The assembly further comprises a valve attached to the container for selectively dispensing the liquid product from the container as a mist. The valve comprises an actuator cap with an insert which comprises an exit orifice and a heater that at least partially surrounds the exit orifice

The beater may be disposed in the insert. In contrast, the heater may be embedded in the actuator cap and surround or substantially surround the insert. As yet another alternative, the insert may be metallic and may be heated by resistance or induction heating. Still another option would be to fabricate a unitary actuator cap without a separate insert with the heater being built into the actuator cap and surrounding the exit orifice. In addition to resistance or induction heating, additional heating techniques may be employed such as radio frequency (RF)

The container may comprise an interior surface coated with a polymeric coating to prevent or retard migration of compressed gas propellant through the container wall. The compressed gas propellant may comprise carbon dioxide, nitrogen or a combination of carbon dioxide and nitrogen In any event, the compressed gas propellant is soluble in the liquid product at low temperatures and less soluble or relatively insoluble at higher temperatures.

The actuator cap may comprise a post disposed downstream of a primary passage in the actuator cap and upstream of the outlet The post mateably receives the insert which comprises a bore that serves as an exit orifice. For compressed gas aerosol systems, performances may be enhanced by increasing turbulence. One way of providing turbulence is with a swirl chamber. The swirl chamber may be formed by the insert and post. The swirl chamber may be disposed between the primary passage and the exit orifice.

In a refinement, the heater at least partially surrounds the swirl chamber.

Turbulence may also be increased by providing a break-up bar The insert may include the break-up bar. Inserts without break-up bars are also suitable and within the scope of this disclosure.

In another refinement, the compressed gas propellant comprises carbon dioxide which is soluble in the liquid product at room temperature and wherein the heater heats the liquid product and dissolved carbon dioxide in the swirl chamber to produce bubbles of carbon dioxide as the solubility of carbon dioxide in the liquid product is reduced by the heating. The production of carbon dioxide bubbles (i.e, cavitation) in the exit stream results in the formation of unstable ligaments of liquid product in the exit stream. These unstable ligaments are then converted into droplets in the exit stream. Preferably, the pressure and exit stream is sufficient to result in further atomization of the primary droplets into smaller droplets.

In a refinement, the dispensed mist has a particle size of less than 35 μm over at least 75% of the life of the dispenser assembly.

In a refinement, the dispenser assembly is capable of dispensing over 90% by weight of the liquid product from the container

In a refinement, the heater is a positive temperature coefficient (PTC) heater.

In a refinement, the assembly further comprises a battery for powering the heater.

In a refinement, a method is disclosed for providing an aerosol mist using a compressed gas propellant. The method comprises providing a pressurized container holding a liquid product and a compressed gas propellant within a container body. The compressed gas propellant comprises a gas that is soluble in the liquid product at room temperature and that has a reduced solubility in the liquid product at temperatures exceeding room temperature. The container further comprises a valve attached to the container for selectively dispensing an exit stream of liquid product and compressed gas propellant through an exit orifice and a heater near the exit orifice. The method further comprises activating the valve to dispense liquid product and propellant through the exit orifice and heating the exit orifice to reduce the solubility of the compressed gas propellant in the liquid product in the exit stream. The method further comprises generating cavitation in the exit stream by forming bubbles of gas propellant and ligaments of liquid product in the exit stream, and converting the ligaments into droplets of liquid product in the exit stream.

In a refinement, the droplets produced by the above method have a Sauter mean diameter of less than 35 μm.

In a refinement the method further comprises converting the droplets to smaller droplets through secondary atomization in the exit stream

In a refinement, the valve used in the above method comprises an actuator cap comprising a primary passage and exit orifice with a post disposed in the exit orifice and downstream of a primary passage The post mateably receives an insert which comprises a bore providing communication between the primary passage and the exit orifice. The insert and post further defining a swirl chamber between the post and the bore.

In a refinement, a Weber number for the droplets is sufficiently high thereby resulting in secondary atomization in the exit stream For example, the inventors have identified a Weber number of 8 or above is sufficiently high for such a purpose.

Another disclosed aerosol dispenser assembly comprises a container holding a liquid product and a compressed gas propellant comprising carbon dioxide for propelling the liquid product from the container. The carbon dioxide is soluble in the liquid product at room temperature with a reduced solubility in the liquid product at temperatures exceeding room temperature. The assembly further comprises a valve attached to the container for selectively dispensing the liquid product from the container as a mist. The valve comprises an actuator cap having an exit orifice and a heater that at least partially surrounds the exit orifice The heater heats the liquid product and dissolved carbon dioxide in the exit orifice to produce bubbles of carbon dioxide and ligaments of liquid product in the exit stream as the solubility of carbon dioxide in the liquid product is reduced by the heating and the ligaments of liquid product that are converted in the exit orifice into droplets having a mean diameter of less than 35 μm

In one aspect, the solubility of carbon dioxide in many liquid products is exploited. Specifically, carbon dioxide is soluble in numerous polar liquid products at relatively low temperatures, including room temperature. However, a heating of the liquid product and dissolved carbon dioxide results in the formation of bubbles of carbon dioxide, resulting in cavitation or the formation of unstable liquid product ligaments in the exit stream. These unstable ligaments are then converted into droplets having relatively small Sauter mean diameters of less than 35 μm

Preferably, the droplets formed in the exit stream have a sufficiently high Weber number thereby enabling the droplets to be converted into smaller droplets in the exit stream through secondary atomization.

In accordance with one aspect of the disclosure, an aerosol dispenser assembly is provided comprising a container at least partially filled with a propellant; a valve assembly coupled to the container; and an actuator cap coupled to the valve assembly, the actuator cap comprising an exit orifice and a heater

In accordance with another aspect of the disclosure, an aerosol dispenser assembly is provided comprising a non-corrosive container at least partially filled with a propellant, wherein the propellant is a highly soluble gas having a solubility that decreases rapidly with increase in temperature; a valve assembly coupled to the container; and an actuator cap coupled to the valve assembly for selectively dispensing droplets of a liquid product, the actuator cap comprising an exit orifice and a heater.

In accordance with another aspect of the disclosure, an aerosol dispenser assembly is provided comprising a non-corrosive container at least partially filled with a propellant, wherein the propellant is a highly soluble gas having a solubility that decreases rapidly with increase in temperature; a coating within an interior of the container, wherein the coating is non-permeable to the propellant; a valve assembly coupled to the container; and an actuator cap coupled to the valve assembly, the actuator cap comprising an exit orifice and a PTC heater

In accordance with another aspect of the disclosure, a method for dispensing fine droplets from a compressed gas aerosol system is provided comprising the steps of providing an aerosol system comprising a pressurized container at least partially filled with a liquid product and a propellant, wherein the propellant is a highly soluble gas having a solubility that decreases rapidly with increase in temperature, the aerosol system further comprising a valve assembly, an actuator cap, an exit orifice and a heater; activating the actuator cap and the valve assembly and passing the liquid product and the propellant toward the exit orifice; instantaneously heating the liquid product and the propellant at the exit orifice; and dispensing the liquid product in the form of thin ligaments with sufficient velocity.

Other advantages and features will be apparent from the following detailed description when read in conjunction with the attached drawings

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is a partial cross-sectional perspective view of an aerosol dispenser assembly made in accordance with this disclosure.

FIG. 2 is a partial front sectional view of an aerosol assembly made in accordance with this disclosure

FIG. 3 is a front elevational view of an actuator cap made in accordance with this disclosure

FIG. 4 is an enlarged partly sectional view of the actuator cap shown in FIG. 3.

FIG. 5 is an exploded cross-sectional view of the actuator cap, stem and insert shown in FIGS. 3 and 4.

FIG. 6 is a front view of the insert shown in FIGS. 4 and 5.

FIG. 7 is a rear view of the insert shown in FIGS. 4-6.

FIG. 8 is a cross-sectional view taken substantially along line 8-8 of FIG. 7.

FIG. 9 is a partial cross-sectional view of yet another aerosol dispenser assembly made in accordance with this disclosure.

FIG. 10 is a cross-sectional view of the insert used in the aerosol dispenser valve shown in FIG. 9

FIG. 11 is a rear view of the insert shown in FIG. 10.

FIG. 12A is a partial sectional view of the actuator cap shown in FIG. 1, particularly illustrating the placement of a heater adjacent in the insert at least partially surrounding the swirl chamber.

FIG. 12B is a side sectional view of the insert shown in FIG. 12A

FIG. 13 is a side sectional view of an insert equipped with a break-up bar.

FIG. 14 is another side sectional view of the insert shown in FIG. 13.

FIG. 15 is another side sectional view of the insert shown in FIGS. 13-14.

FIG. 16 is a front plan view of the insert shown in FIGS. 13-15

FIG. 17 is a rear plan view of the insert shown in FIGS. 13-16.

FIG. 18 is a front perspective view of the insert shown in FIGS. 13-17.

FIG. 19 is a rear perspective view of the insert shown in FIGS. 13-18.

It should be understood that the drawings are not to scale and that the disclosed embodiments are sometimes illustrated diagrammatically and in partial views In certain instances, details which are not necessary for an understanding of the disclosed methods and apparatuses or which render other details difficult to perceive may have been omitted. It should be understood, of course, that this disclosure is not limited to the particular embodiments illustrated herein

### DETAILED DESCRIPTION OF THE DISCLOSURE

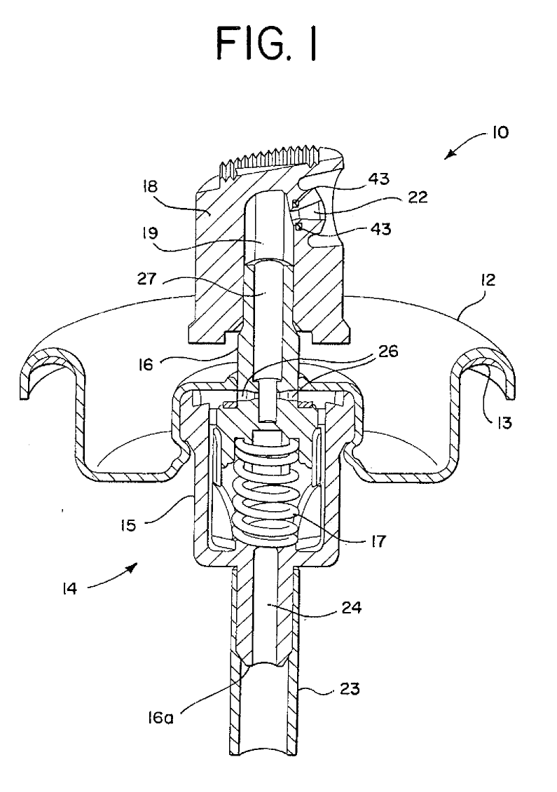

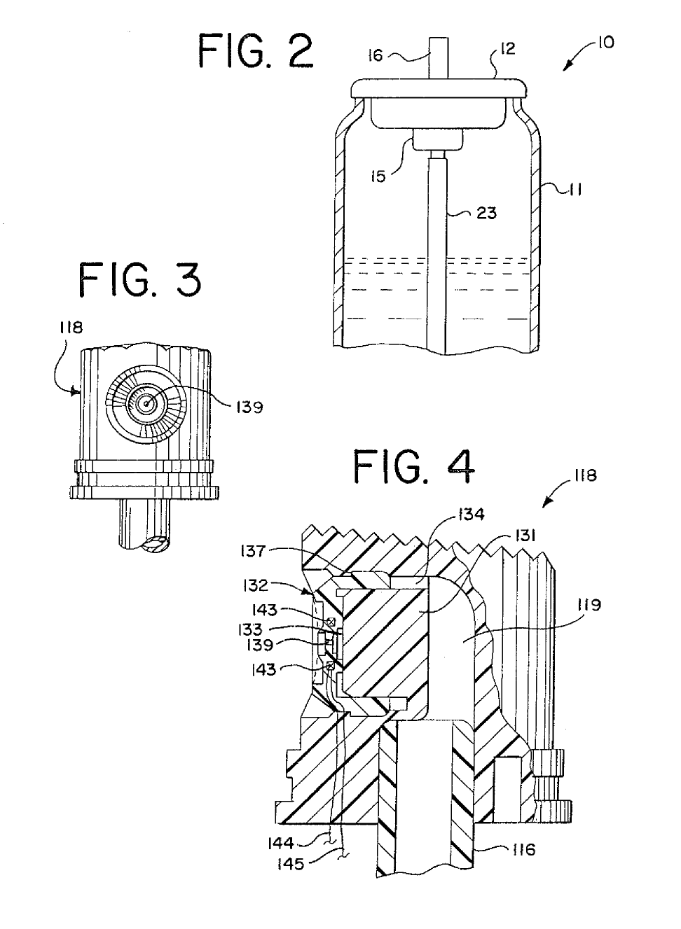

As shown in FIGS. 1 and 2, an aerosol dispenser assembly 10 includes a container 11 covered by a mounting cup 12. A mounting gasket 13 is disposed between an upper rim (not shown) of the container 11 and the underside of the mounting cup 12. A valve assembly 14 is used to selectively release the contents from the container 11 to the atmosphere. The valve assembly comprises a valve body 15 and a valve stem 16. The valve stem 16 includes a lower end 16a that is mounted through a return spring 17. An actuator cap 8 is mounted on top of the valve stem 16 and defines a primary passageway 19. The actuator cap 18 also defines an exit orifice shown generally at 22 and which will be discussed in greater detail below.

The valve body 14 is affixed to the underside of the mounting cup 12 by a friction fit and the valve stem 16 extends through the friction cup 12. The actuator cap 18 is frictionally fitted onto the upwardly extending portion of the valve stem 16. The lower end of the valve body 15 is connected to a dip tube 23. Gaskets may or may not be required between the valve body 15 and the mounting cup 12 and between the valve stem 16 and the mounting cup 12, depending upon the materials used for each component Suitable materials will be apparent to those skilled in the art that will permit a gasket-less construction Similarly, gaskets or seals are typically not required between the actuator cap 18 and the upper portion of the valve stem 16.

While the dispenser assembly 10 of FIGS. 1-2 employs a vertical action-type cap 18, it will be understood that other actuator cap designs may be used such as an actuator button with an integral over cap, a trigger actuated assembly, a tilt action-type actuator cap or other designs.

In operation, when the actuator cap 18 is depressed, it forces the valve stem 16 to move downward thereby allowing liquid product to be dispensed. The propellant forces the liquid product up the dip tube 23 and into the valve body 15 via the orifice or passageway 24. From the valve body 15, the liquid product is propelled through the stem orifices 26, out the passageway 27 through the valve stem 16 and through the primary passageway 19 of the actuator cap to the exit orifice 22. Preferably, two valve stem orifices 26 are employed although a single valve stem orifice or up to four valve stem orifices may be used. Multiple valve stem orifices 26 provide greater flow and superior mixing of the product.

The use of an insert and a post within the actuator cap 18 is not specifically shown in FIG. 1 but is illustrated in FIGS. 3-14 below However, a heater 43 is shown schematically in FIG. 1. Typically, aerosol dispensers include a post-like structure built into the actuator cap and an insert that covers the post in the exit orifice. A heater can be employed in the insert or in the actuator cap around the insert to provide heat to the swirl chamber as described below Also, the insert itself may be metallic for induction or resistive heating One example of such construction is illustrated in FIGS. 3-8.

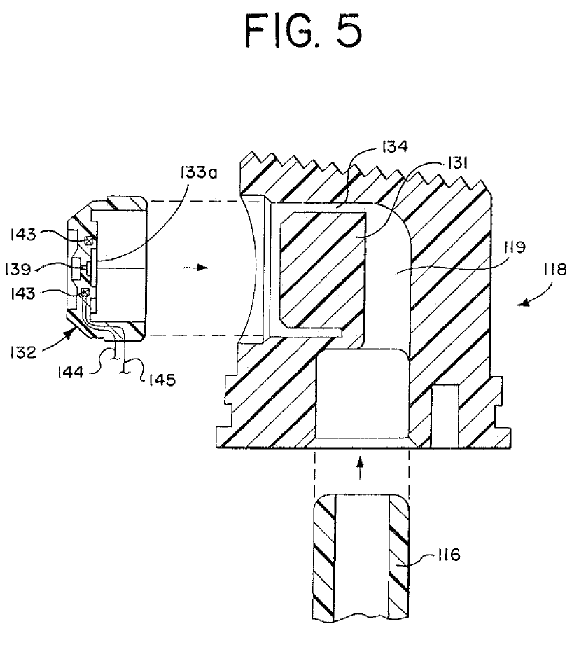

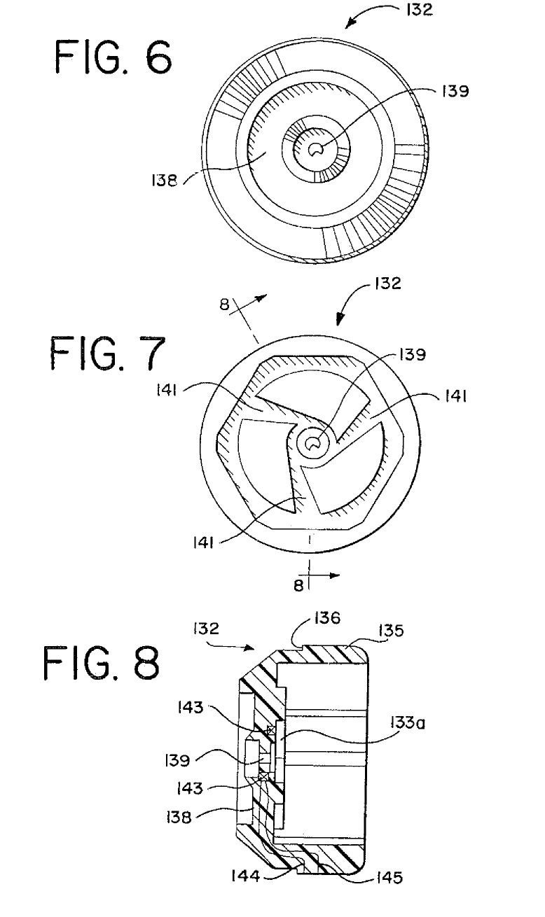

Specifically, referring to FIG. 3, an actuator cap 118 is disclosed with a primary passageway 119. Disposed within the passageway 119 is a post 131 that is connected to or formed integrally from the actuator cap 118. The post 131 mateably receives an insert 132 as illustrated in FIGS. 4-5. In the embodiment illustrated in FIGS. 3-5, the actuator cap 118 fits directly onto the valve stem 116 without the inclusion of a break-up bar (see reference numeral 21 in FIG. 1). Disposed between the insert 132 and the post 131 is a small swirl chamber shown at 133 in FIG. 4. Communication is provided to the swirl chamber 133 through the connecting passage 134. Details regarding the construction of the insert or suitable inserts that may be used in accordance with this disclosure are provided in FIGS. 6-8, 10 and 13.

A heater 143 is disposed within the insert 132 and surrounds the swirl chamber 133 to heat the prospect/propellant mixture passing through the swirl chamber 133. As discussed below in connection with FIGS. 12-14, the heating generates bubbles of propellant in the exit stream, causing cavitation, the formation of unstable liquid product ligaments and eventually, small droplets of product having diameters of less than 35 μm. Further, the insert 132 may be fabricated from metal so that the entire insert 132 serves as a resistance heater connected to tho electrical leads 144, 145.

Turning to FIGS. 6-8, the insert 132 is shown in greater detail. The recess 133a provides the space necessary for the swirl chamber 133 shown in FIG. 4. The cylindrical sidewall 135 includes a raised portion that results in a step 136 that engages a catch 137 built into the actuator cap 118 thereby enabling the insert 132 to be press-fit into the actuator button 118. The insert 132 has a front wall 138 and a discharge orifice 139. Additional details regarding the construction of the insert 132 and post 131 as shown in FIGS. 3-8 can be found in U.S. Pat. No. 4,071,196.

The heating element 143 and electrical leads 144, 145 are shown in FIG. 8 However, as noted above, the entire insert 132 may be fabricated from a high resistance metallic material and therefore the entire insert 132 may serve as a resistance heater. The entire insert 132 may also serve as an induction heating element.

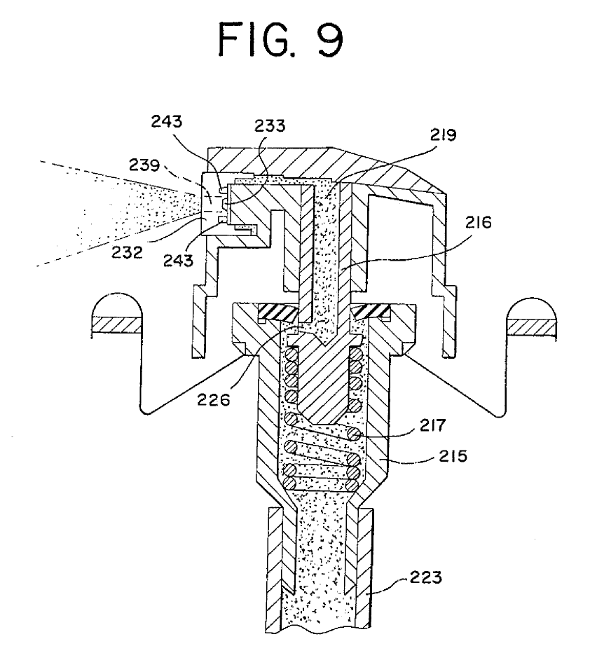

Turning to FIGS. 9-12, a similar construction is shown whereby the valve body 215 is mounted onto a dip tube 223 and beneath a valve stem 216. The actuator cap 218 also includes a post 231 which mateably receives an insert 232 to provide a swirl chamber 233 therebetween as shown in FIG. 9. A stem orifice is shown at 226 and a return spring at 217 The mounting cup and gasket are shown at 212, 213, respectively.

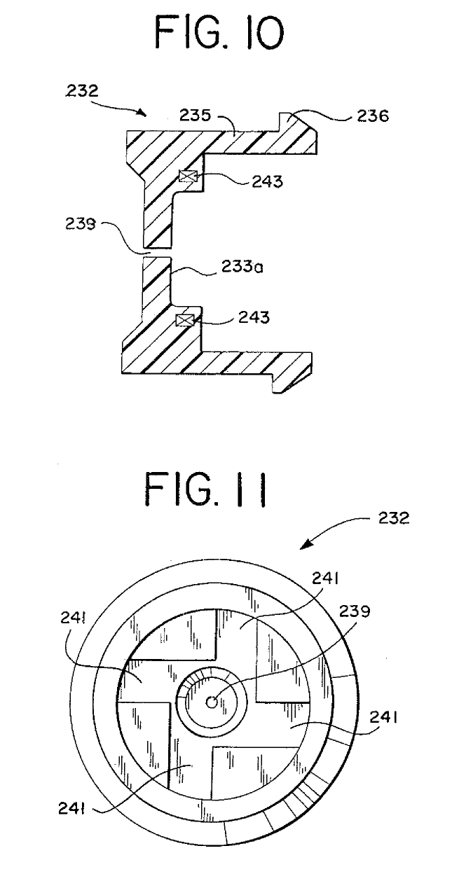

Details of the insert 232 are provided in FIGS. 10-12. The insert 232 includes a cylindrical wall 235 with a barb or catch shown at 236 for engaging a recess disposed in the actuator cap body 218. The discharge orifice as shown at 239 in the front wall at 238 The recess 233a provides ample space for a swirl chamber 233 (see FIG. 9). Like the insert 132 as shown in FIG. 7, the insert 232 includes channels 241 directed toward the recess 233a and therefore the swirl chamber 233. The insert 232 also includes a heating element 243.

Turning to FIGS. 12A-12B, the insert 332 is shown equipped with a PTC resistive heating element 243 that essentially surrounds the swirl chamber 333 As liquid product passes the cross-bar 321 in the passageway 319, and proceeds past the post 331, into the swirl chamber 333, the heating element 243 heals the product flow stream thereby reducing the solubility of any compressed gas propellant in the exit stream 350 As a result, cavitation occurs, or bubbles of compressed gas propellant appear in the product flow stream thereby creating unstable thin ligaments of liquid product in the exit stream 350. The unstable thin ligaments of liquid product are then converted into small droplets having diameters of less than 35 μm. If a suitable pressure is provided within the container, and a suitable velocity is imparted to the primary droplets, the droplets will then further divide into smaller droplets by way of an atomization process.

It is believed that the cavitation process starts within the swirl chamber 333 and continues as the product flows through the discharge orifice 339 and into the exit orifice 322. A variety of different heaters can be employed, and while a simple resistance heating element may be used, a PTC heating element is preferred as it can easily maintain a constant temperature in the swirl chamber 333. Electrical leads for the heater 343 are shown at 344, 345. Examples of PTC heaters can be found in U.S. Pat. Nos. 3,927,300, 3,338,476, 4,088,269, 4,212,425, 6,220,524 and 6,501,907 See also U.S. Pat. No. 3,476,293.

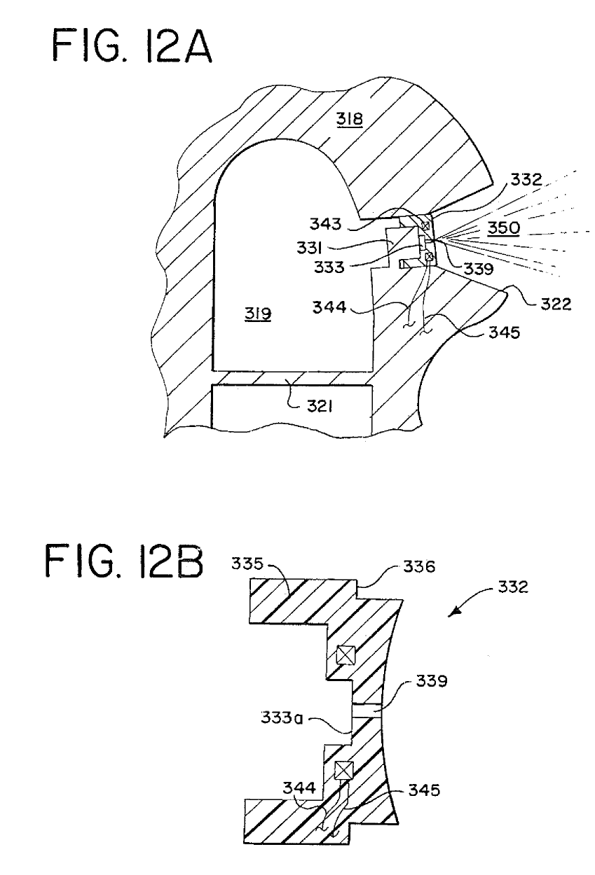

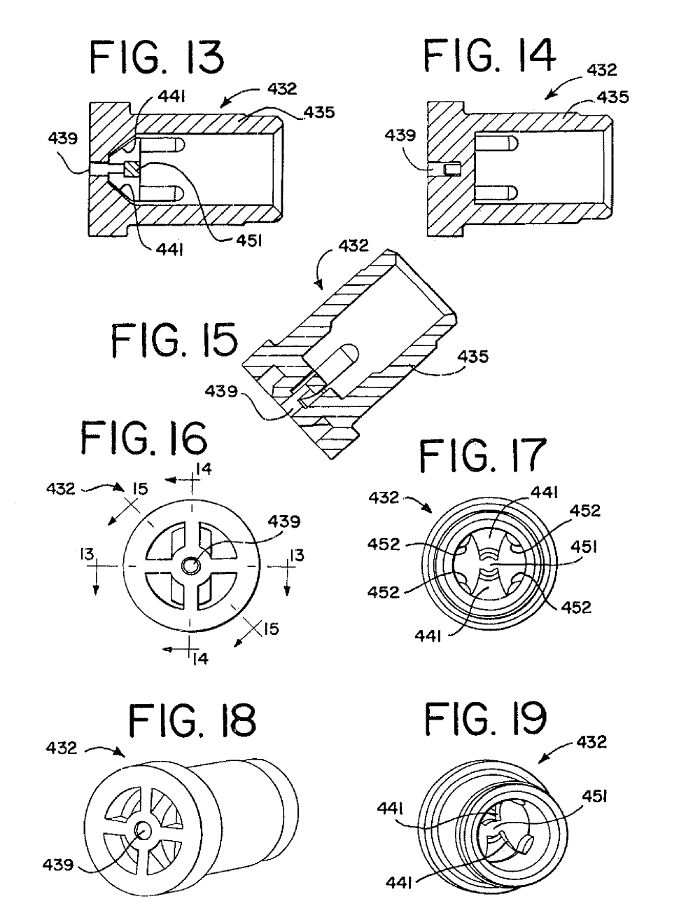

Turning to FIGS. 13-19, an insert 432 is disclosed that includes a breakup bar 451. Essentially, as best seen in FIG. 19, two opposing channels 441 are disposed in the insert 432. As product travels towards the exit orifice 439, the product is directed through the oppositely directed channels 441 so the product engages the breakup bar and other product to provide highly turbulent flow before it reaches the exit orifice 439. FIG. 17 illustrates the placement of the oppositely directed channels 441 between four circumferentially spaced posts 452 which further promote turbulent swirling flow as product moves toward the exit orifice 439

In summary, an improved aerosol dispensing system is disclosed which enables a compressed gas propellant, such as carbon dioxide, to be used to deliver liquid product. Preferably, compressed gas propellant should be soluble in the liquid product at room temperature and less soluble or relatively insoluble in elevated temperatures. Thereby, the heating of the exit stream will result in cavitation or propellant bubbles emerging in the exit stream to form unstable thin ligaments These unstable thin ligaments will then be converted into droplets which preferably will have a Weber number sufficiently high so as to result in secondary atomization and even smaller droplets. In any event, the proposed designs provide an aerosol mist with a mean Sauter diameter of less than 35 μm.

While only certain embodiments have been set forth, alternatives and modifications will be apparent from the above description to those skilled in the art. These and other alternatives are considered equivalents and within the spirit and scope of this disclosure and the appended claims

### INDUSTRIAL APPLICABILITY

An improved aerosol dispenser is provided using a compressed gas propellant free of volatile organic compounds and that includes an actuator cap equipped with a heater for reducing the particle size of the resulting mist

What is claimed is:

1. An aerosol dispenser assembly, comprising:
a container at least partially filled with a propellant;
a valve assembly coupled to the container; and
an actuator cap coupled to the valve assembly, the actuator cap comprising an exit orifice and a heater.

2. The aerosol dispenser assembly of claim 1, wherein the container is non-corrosive

3. The aerosol dispenser assembly of claim 1, wherein the propellant is a highly soluble gas having a solubility that decreases rapidly with increase in temperature

4. The aerosol dispenser assembly of claim 1, wherein the propellant is carbon dioxide.

5. The aerosol dispenser assembly of claim 1 further comprising a coating within an interior of the container, wherein the coating is non-permeable to the propellant.

6. The aerosol dispenser assembly of claim 1, wherein the actuator cap further comprises an insert.

7. The aerosol dispenser assembly of claim 6, wherein the heater is disposed within the insert.

8. The aerosol dispenser assembly of claim 1, wherein the heater is a positive temperature coefficient (PTC) heater.

9. The aerosol dispenser assembly of claim 1 further comprising a swirl chamber disposed within the actuator cap.

10. An aerosol dispenser assembly, comprising:
a non-corrosive container at least partially filled with a propellant, wherein the propellant is a highly soluble gas having a solubility that decreases rapidly with increase in temperature;
a valve assembly coupled to the container; and
an actuator cap coupled to the valve assembly for selectively dispensing droplets of a liquid product, the actuator cap comprising an exit orifice and a heater

11. The aerosol dispenser assembly of claim 10, wherein the propellant is carbon dioxide

12. The aerosol dispenser assembly of claim 10 further comprising a coating within an interior of the container, wherein the coating is non-permeable to the propellant.

13. The aerosol dispenser assembly of claim 10, wherein the actuator cap further comprises an insert.

14. The aerosol dispenser assembly of claim 13, wherein the heater is disposed within the insert.

15. The aerosol dispenser assembly of claim 10, wherein the heater is a PTC heater.

16. The aerosol dispenser assembly of claim 10, wherein the dispensed droplets have a Sauter mean diameter of less than 35 μm.

17. An aerosol dispenser assembly, comprising:
a non-corrosive container at least partially filled with a propellant, wherein the propellant is a highly soluble gas having a solubility that decreases rapidly with increase in temperature;
a coating within an interior of the container, wherein the coating is non-permeable to the propellant;
a valve assembly coupled to the container; and
an actuator cap coupled to the valve assembly, the actuator cap comprising an exit orifice a PTC heater.

18. The aerosol dispenser assembly of claim 17, wherein the propellant is carbon dioxide

19. The aerosol dispenser assembly of claim 17, wherein the PTC heater is disposed within the insert.

20. A method for dispensing fine droplets from a compressed gas aerosol system, comprising the steps of:
providing an aerosol system comprising a pressurized container at least partially filled with a liquid product and a propellant, wherein the propellant is a highly soluble gas having a solubility that decreases rapidly with increase in temperature, the aerosol system further comprising a valve assembly, an actuator cap, an exit orifice and a heater;
activating the actuator cap and the valve assembly and passing the liquid product and the propellant toward the exit orifice;
instantaneously heating the liquid product and the propellant at the exit orifice; and
dispensing the liquid product in the form of thin ligaments with sufficient velocity

21. The method of claim 20, wherein the heater is a PTC heater.

22. The method of claim 20 further comprising the step of rapidly decreasing the solubility of the propellant

23. The method of claim 20 further comprising the step of generating cavitation within the liquid product at the exit orifice.

24. The method of claim 20, wherein the dispensed droplets have a Sauter mean diameter of less than 35 μm

25. The method of claim 20, further comprising converting the droplets to smaller droplets through secondary atomization in the exit stream.
